(19) United States
(12) Patent Application Publication
(10) Pub. No.: US 2009/0241056 A1
(43) Pub. Date: Sep. 24, 2009

(54) SYSTEMS AND METHODS FOR DISPLAY AND MODIFICATION OF INFORMATION RELATED TO MULTIPLE BUSINESSES

(76) Inventors: Nancy L. Augustine, Pleasant Hill, CA (US); John Carr, Antioch, CA (US); Ben Goldberg, Pleasanton, CA (US); Randall Jones, Carrollton, TX (US); Cheryl L. Paterson, Alameda, CA (US); Ev Shafrir, Mountain View, CA (US); Gregg Stratton, San Francisco, CA (US)

Correspondence Address: WILSON SONSINI GOODRICH & ROSATI, 650 PAGE MILL ROAD, PALO ALTO, CA, 94304-1050, US

(21) Appl. No.: 12/053,530

(22) Filed: Mar. 21, 2008

(51) Int. Cl. G06F 3/048

(52) U.S. Cl. 715/781

(57) ABSTRACT

Systems and methods for accessing data related to managing a business for multiple businesses may include a user interface with a businesses pane and an information pane. The businesses pane can provide a list of one or more business entities and allow a user to display data related to a selected business from the list of one or more business entities. An information pane can display data related to the selected business using one or more mini-tabs. The mini-tabs can allow for one or more sets of data to be displayed, including payroll or human capital management data. The information pane can display an interface to perform actionable tasks related to the selected business.

### FIELD OF THE INVENTION

This invention is directed to systems and methods of display and modification of data for management of multiple businesses. The invention may be applied to payroll or human capital management software, which may provide means for displaying and modifying payroll or other human capital management data.

### BACKGROUND OF THE INVENTION

Every employer is faced with the regular generation of payroll for its employees. Initially, payroll processing was an arduous manual task, requiring the responsible individual to compute the base pay, applicable taxes, and other deductions for each of the employer's employees. Initially, these calculations were performed by hand. Over time, automated systems have been developed to calculate pay, produce payroll checks, and even to make the automatic payroll deposits into an employee's bank account for employees participating in a direct deposit program. Automated systems have also been developed to deal with over human capital management.

Many companies choose to outsource their payroll needs to a third party that specializes in payroll services. In this case, the third party may provide service for multiple businesses. For a payroll service provider, simplified access to data relating to multiple businesses can be a valuable feature. However, payroll or human capital management systems have not been developed for to simplify accessing data relevant to a plurality of businesses on a single page.

Therefore, there is a need for improved systems and methods for displaying payroll or other human capital management data relevant to a plurality of businesses on a single page.

### SUMMARY OF THE INVENTION

The invention provides systems and methods for displaying data related to managing multiple businesses. Various aspects of the invention described herein may be applied to any of the particular applications set forth below or for any other types of user interfaces and displays. The invention may be applied as a standalone system or method, or as part of an integrated software package, such as for payroll or human capital management software. It shall be understood that different aspects of the invention can be appreciated individually, collectively, or in combination with each other.

While some embodiments disclose use of the invention for payroll data, the embodiments disclosed herein are not limited only to payroll data or payroll systems. The term payroll can be interchanged with the term human capital management, where human capital management pertains to the organization or management of human assets or manpower. For instance, human capital management may include data such as payroll data (including items such as wage compensation and benefits), workforce planning, recruitment, induction/orientation, skills management, training and development, personnel administration, time management, travel management, personnel cost planning, or performance appraisal.

The system for accessing payroll data can comprise a client computer, a server operably connected to the client computer, and a database coupled to the server to store data. The client computer can have a user interface for accessing payroll data. The user interface for accessing payroll data can comprise a businesses pane providing a list of businesses and an information pane providing information relating to each business within the list of businesses. The information pane can include one or more mini-tabs to display one or more sets of data related to a selected business from the list of businesses. The one or more mini-tabs can display one or more actionable tasks. The information pane can include an interface to perform a selected actionable task from the displayed one or more actionable tasks.

The information pane can include a payroll mini-tab for displaying payroll data. The payroll mini-tab can display one or more of the following: payroll data that requires action, payroll data relating to a period of time, payroll data relating to a pay period, or employee work group information. The payroll mini-tab can include a button or a link to edit payroll data, create a new sheet to store data, or perform an action with payroll data.

The information pane can include a mini-tab to display data related to managing a business. In some embodiments of the invention, the information pane can include a mini-tab to display data selected from the group consisting of employee data, company contact data, company historical data, company status data, shipping data, receiving data, order data, billing data, and transfer data.

A mini-tab to display employee data can include a list of one or more employee records. An employee record can be accessed without a search. Additional employee data relating to an employee can be displayed by selecting an employee record.

In other embodiments of the invention, the information pane can include a search function that searches any data related to a selected business from a list of businesses included in a businesses pane. The search function can rank one or more hits based on the relevance of the one or more hits. A hit can be any data that corresponds to a search criterion. In some embodiments of the invention, a mini-tab can include a search function. The search function can rank one or more hits related to the mini-tab higher than one or more hits not related to the mini-tab. The search function can be limited to search only data related to the selected business from the list of businesses. In other embodiments of the invention, the search function can be a find function, wherein the find function can sort one or more hits. A mini-tab can include a find function that can search data related to the mini-tab and/or data not related to the mini-tab. The find function can distinguish between data related to the mini-tab and data not related to the mini-tab prior to performing the search. The find function can be performed without ranking the one or more hits.

The invention can provide for a method of implementing a user interface for accessing payroll data that can comprise displaying within the user interface a businesses pane that can provide a list of businesses and an information pane that can provide information relating to each business within the list of businesses, wherein the information pane can include one or more mini-tabs for displaying one or more sets of data related to a selected business from the list of businesses.

The invention can provide for a computer readable medium having program instructions recorded thereon for implementing a method that can comprise displaying a businesses pane that can provide a list of businesses and an information pane that can provide information relating to each business within the list of businesses. The information pane can include one or more mini-tabs for displaying one or more sets of data related to a selected business from the list of businesses. The one or more mini-tabs can include a payroll mini-tab for displaying payroll data.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The features and advantages of the invention may be further explained by reference to the following detailed description and accompanying drawings that sets forth illustrative embodiments.

FIG. 1 is an illustration showing a system with client computers interacting with a server.

FIG. 2 is an illustration showing a user interface including a businesses pane and an information pane.

FIG. 3 is an illustration showing an embodiment of a user interface including a businesses pane and an information pane displaying a payroll mini-tab.

FIG. 4 is an illustration showing an alternate embodiment of a user interface including a businesses pane and an information pane displaying a payroll mini-tab including a button for starting a payroll.

FIG. 5 is an illustration showing an embodiment of a user interface including a businesses pane and an information pane displaying a mini-tab containing company data.

FIG. 6 is an illustration showing an embodiment of a user interface including a businesses pane and an information pane displaying a mini-tab containing employee data.

FIG. 7 is a flow chart showing a sequence for displaying data related to multiple businesses and for displaying an interface for data modification.

FIG. 8 is a flow chart showing a sequence for displaying data related to multiple businesses and for intelligently displaying data related to managing a business.

### DETAILED DESCRIPTION OF THE INVENTION

While preferable embodiments of the invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

While some embodiments disclose use of the invention for payroll data, the embodiments disclosed herein are not limited only to payroll data or payroll systems. The term payroll can be interchanged with the term human capital management, where human capital management can pertain to the organization or management of human assets or manpower. The term human capital management can include workforce planning, recruitment, attraction and selection, induction, orientation, skill management, training, development, personnel administration, compensation, time management, travel management, payroll, accounting, employee benefits administration, personnel cost planning, planning, or performance appraisal.

User Interfaces and Systems for Displaying the Same

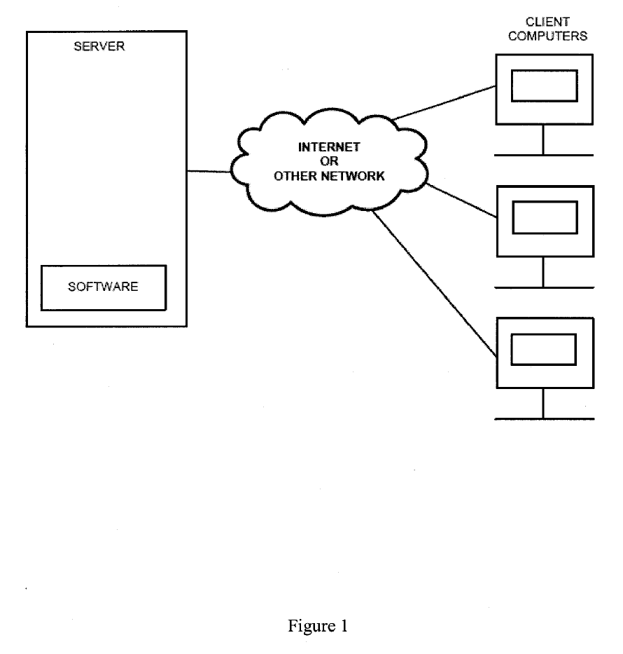

As shown in FIG. 1, a user interface provided in accordance with the invention herein may be implemented using a system comprising a client computer, a server operably connected to the client computer; and a database coupled to the server to store data. The server may be operably connected across a network to a client computer. In some embodiments of the invention, one or more servers can be connected across a network to one or more client computers. The network, for example, can include the Internet or any network for connecting a client to a server. The client computer can have a video display and a user interface presented on the video display for showing business data. The business data may include payroll data.

A video display may include a device upon which information may be displayed in a manner perceptible to a user, such as, for example, a computer monitor, a cathode ray tube, a liquid crystal display, a light emitting diode display, a touchpad or a touchscreen display, and/or other means known in the art for emitting a visually perceptible output. A video display may be electronically connected to a client computer according to hardware and software known in the art.

In one implementation of the invention, a computer file or data residing in memory can be transmitted from a server over a network to a client computer and stored in memory by the client computer. At the client computer, the computer file or data may be interpreted by software residing in memory on the client computer, causing the computer file or data to be displayed as a display page on a video display in a manner perceivable by a user. A display page described herein may be created using a software language known in the art such as, for example, the hypertext mark up language (“HTML”), the dynamic hypertext mark up language (“DHTML”), the extensible hypertext mark up language (“XHTML”), the extensible mark up language (“XML”), or another software language that may be used to create a display page from a computer file or data on a video display in a manner perceivable by a user. Where a network comprises the Internet, a display page may comprise a webpage of a type known in the art.

A display page according to the invention may include embedded functions comprising software programs stored in memory, such as, for example, VBScript routines, JScript routines, JavaScript routines, Java applets, ActiveX components, ASP.NET, AJAX, Flash applets, Silverlight applets, or AIR routines.

A display page may comprise well known features of graphical user interface technology, such as, for example, a frame, a window, a scroll bar, a button, an icon, and a hyperlink, and well known features such as a “point and click” interface. Pointing to and clicking on a graphical user interface button, icon, or hyperlink also is known as “selecting” the button or hyperlink. A display page according to the invention also may incorporate multimedia features.

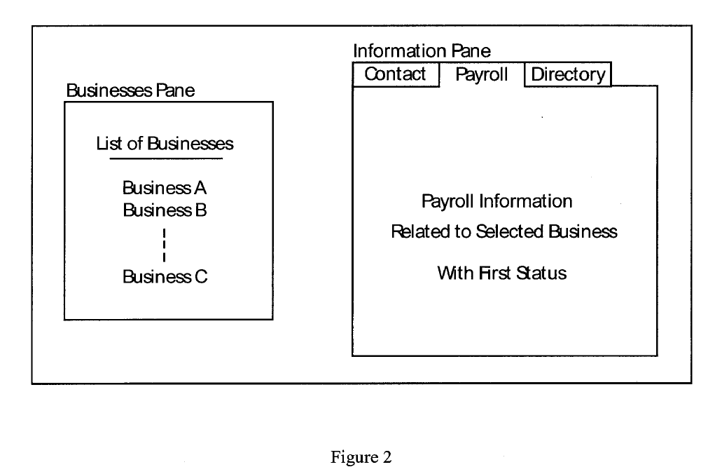

As shown in FIG. 2, a display page may include a businesses pane and an information pane. The businesses pane can display a list of businesses and allow a user to selectively display data relating to a business selected from the list of businesses. The information pane can provide access to data related to a selected business from the businesses pane. A pane may provide access to data in one or more different manners. Providing access to data may include any activity that may lead to creating using, modifying, or viewing the data. The panes do not need to provide access to data in the same manner or format.

The businesses pane can include any means known to those skilled in the art for displaying one or more business entities. In some embodiments of the invention, the businesses pane can display a list of businesses for identifying one or more business entities. The businesses pane can display the one or more business entities using charts, expandable lists, intelligent lists, sorted lists, circular diagrams, or any other visual method for displaying a plurality of items.

The one or more business entities can include businesses, business divisions, individuals, or any entity that can utilize business management services. The businesses pane can identify one or more business entities using a business name, a logo, a symbol, a business code, or any other business entity identifier. A business with multiple divisions can be listed under names corresponding to each division. A division can correspond to geographic regions, practice areas, or any other manner for separating one part of a business from another part of a business.

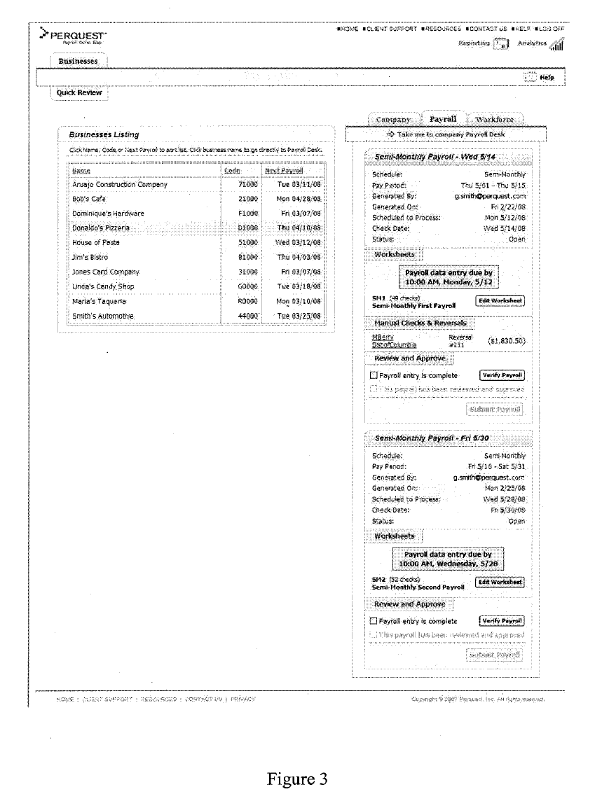

The businesses pane can include a list of businesses and corresponding information related to each business. As shown in FIG. 3, the businesses pane can include one or more of the following: a list of dates indicating a next payroll date and a business code. The business code can be used to identify a business, a business type, or a business class.

The information pane can display data related to a selected business from the list of businesses using any user selectable interface known to one skilled in the arts. In some embodiments of the invention, the information pane can provide one or more mini-tabs for displaying one or more sets of data related to a selected business from the list of businesses.

In some embodiments of the invention, a default set of data can be displayed by an information pane by selecting a business from the list of businesses. For example, regardless of what business a user may select, the information pane may always default to showing a payroll mini-tab.

Alternatively, the set of data displayed by an information pane by selecting a business from the list of businesses can be dependent on the selected business from the list of businesses. For example, selecting a first business may cause a first set of data to be displayed in an information pane, while selecting a second business may cause a second set of data to be displayed in an information pane. This could include the situation where a user may select a first business, which may cause the information pane to default to a payroll mini-tab, while selecting a second business may cause the information pane to default to a directory mini-tab. In one implementation, each business may have a default set of data to be displayed in the information pane, which may be modified or selected by a user.

In other embodiments of the invention, the data to be displayed in the information pane after selecting a business from a list of businesses can be previously set, determined based on the status of the data, or determined by historical use of the data. The data to be displayed in the information after selecting a business from a list of businesses can be the data that is most relevant to the selected business.

In other embodiments of the invention, the information pane can include a search function to be displayed when a selecting a business from the list of businesses. The search function can search any data related to the selected business, rank one or more hits for relevance to the search, and report the one or more hits based on a corresponding rank.

In some embodiments of the invention, the one or more mini-tabs can display any data related to managing a business or human capital management data. For example, the one or more mini-tabs can display data related to payroll data, employee data, company contact data, company historical data, company status data, shipping data, receiving data, order data, billing data, and transfer data. The mini-tabs for displaying data can have any name that can be used to identify the data displayed when the mini-tab is selected.

The user interface for accessing human capital management data can be used to provide human capital management service to one or more businesses. The one or more businesses may outsource their human capital management to a service provide using the user interface of the invention. The one or more businesses can have heterogeneous types of data. In some embodiments of the invention, the one or more businesses can be classified based on the primary type of data that is to be accessed. For example, a business can be classified by a primary type of data such as payroll, employee benefits administration, employee skill management, or accounting. The user interface can include an information pane with a set of mini-tabs for displaying and accessing a primary type of data and other types of data related to managing a business. For example, a set of mini-tabs for displaying and accessing payroll data can include a mini-tab for payroll data, a mini-tab for company data, and a mini-tab for employee specific data. As another example, a set of mini-tabs for displaying and accessing employee benefits administration can include a mini-tab for insurance plan data, a mini-tab for vacation data, a mini-tab for salary and/or bonus data, and a mini-tab for employee specific data.

In other embodiments of the invention, the one or more mini-tabs can display one or more actionable tasks. The information pane can provide an interface to perform the one or more actionable tasks. The interface to perform the one or more actionable tasks can be displayed within a mini-tab.

The information pane can be tailored such that one or more tailored mini-tabs are displayed for each business. The ability to tailor the one or more mini-tabs displayed for each business can allow the user interface to be used to record, access, or use data from a heterogeneous set of one or more businesses. For example, the heterogeneous set of one or more business may have different methods or systems for recording, accessing or using payroll data. Some businesses may have employees that are salaried, while other businesses may have employees that are paid on an hourly basis.

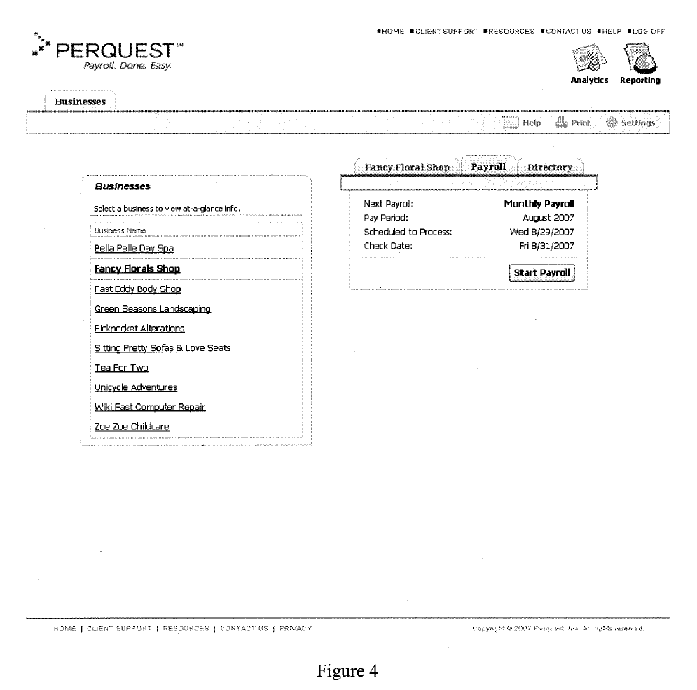

In some embodiments of the invention, the information pane can include a payroll mini-tab to display payroll data and allow the user to perform one or more actions related to the payroll data. As shown in FIG. 3, payroll data can include one or more of the following: an actionable task, a due date, a pay period, a generation date, a check date, a pay schedule, a worksheet, a reversal, or employee work group information. The one or more actions related to the payroll data, which can include performing an actionable task, can be performed by utilizing one or more of the following features: a button, a link, a radio box, and a pop-up box. The payroll mini-tab can include a button or a link for creating a new sheet to store data or to perform an action with the data. In other embodiments of the invention, a user can select to perform an actionable task, wherein the actionable task can be performed using a user interface displayed in the information pane. As shown in FIG. 4, the payroll mini-tab can include a button to start a payroll.

The payroll data that may be displayed in a payroll mini-tab can be related to a period of time, a pay period, or a data status. The payroll data that can be displayed can be determined by previous decisions, by data status, by historical use of the data, by relevance of the data, or by any other intelligent manner for determining what data would be most relevant. For example, the payroll mini-tab can display payroll data that is not yet submitted for review or incomplete. Alternatively, the payroll mini-tab can display a button for starting a new payroll if the current set of payroll data is complete and submitted for review.

In one embodiment of the invention, a mini-tab can display information that is relevant to a current or an upcoming business cycle. A business cycle can be determined by a payroll frequency, a close of a financial period, a shift changeover, or an opening or closing procedure. A data mini-tab can display data depending on a position in a cycle. A cycle can be based on time or any other repeating occurrence. For example, a cycle can be a day, a week, a month, or a pay period. A position in a cycle can be a beginning, a middle or an end. In other embodiments of the invention, a position in a cycle can be any portion of the cycle relevant to managing business data. Data related to one or more cycles can be displayed on one or more mini-tabs.

In other embodiments of the invention, the payroll data can be displayed in the same manner as payroll data can be displayed on a separate page for displaying payroll data rolling sequences, such a page displaying payroll data with more than one payroll period or data status. Embodiments of a page for displaying payroll data rolling sequences are described in U.S. application Ser. No. 12/053,517 and is hereby incorporated by reference.

The information pane can include a mini-tab to display company data related to a selected business from a list of businesses. The mini-tab to display company data can display one or more of the following: a company status, a license number, an indication of license validity, a service level, or any other data related to a company.

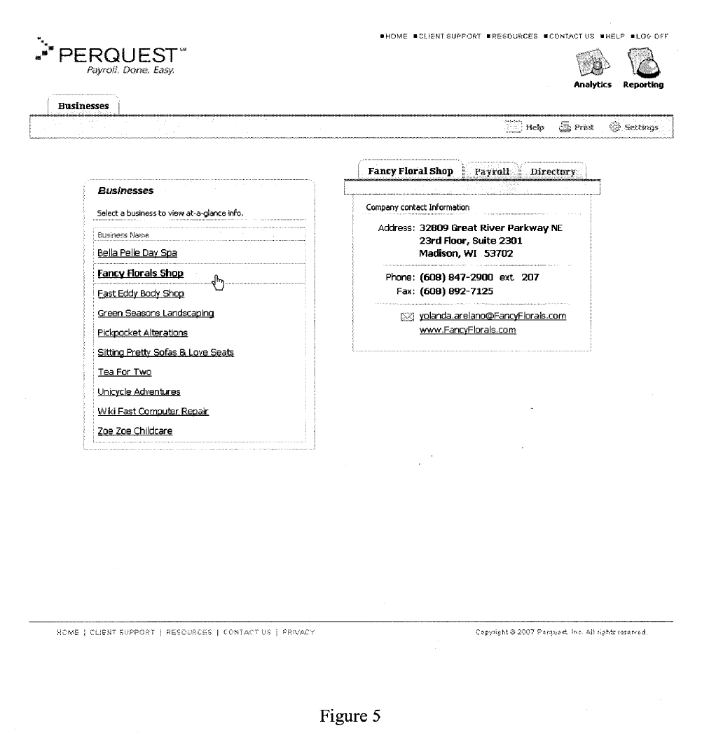

The information pane can include a mini-tab to display company contact data related to a selected business from a list of businesses. As shown in FIG. 5, the mini-tab to display company contact data can display one or more of the following: an address, a phone number, a fax number, an e-mail, or a website. The mini-tab to display company contact data can include one or more hyperlinks for contacting the selected business. Company contact data can be displayed on a mini-tab that can display company data.

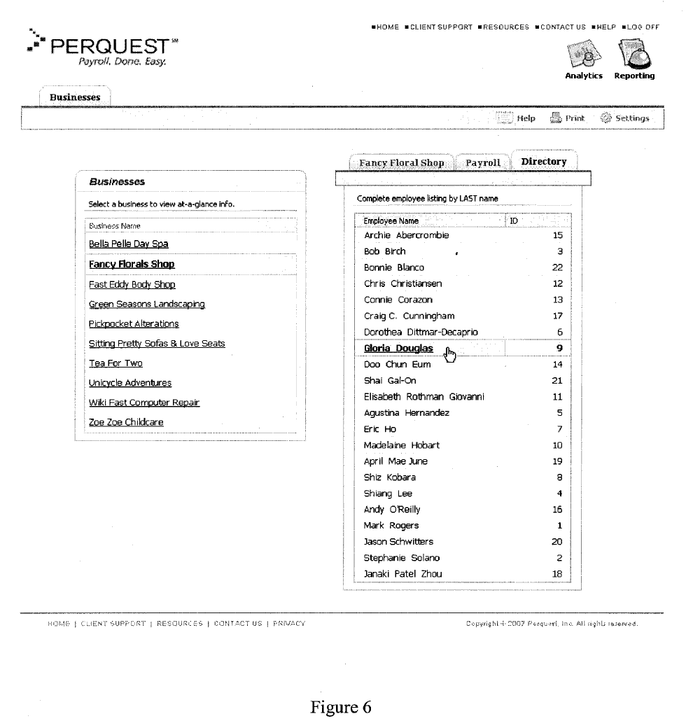

The information pane can include a mini-tab to display employee data related to a selected business from the list of businesses. The mini-tab to display employee data can be called a directory mini-tab. As shown in FIG. 6, the mini-tab to display employee data can include a list of one or more employee records. Selecting an employee record from the displayed one or more employee records can display additional data relating to the selected employee. The user interface of the invention can allow for an employee record to be retrieved in fewer than two, three, four or five clicks. In some embodiments of the invention, the user interface can allow for an employee record to be accessed without a search.

In some embodiments of the invention, the information pane can include a search function. The search function can be used to search any data related a selected business from a list of businesses. The search function can be limited to only search data related to the selected business from the list of businesses. Only searching data related to the selected business from the list of businesses can allow for secure searching. In other embodiments of the invention, the search function can guarantee secure searching.

The search function can intelligently report data by determining the relevance of one or more hits, ranking the one or more hits accordingly, and displaying the one or more hits in an order corresponding to rank. A hit can be any data that corresponds to a search criterion. A hit with a higher relevance can be assigned a higher rank than a hit with a lower relevance. In other embodiments of the invention, the search function can be a find function. The find function can sort one or more hits. In an alternative embodiment of the invention, the find function can be performed without ranking the hits.

In other embodiments of the invention, the information pane can include a mini-tab, wherein the mini-tab contains a search function. The search function within a mini-tab can search all data related to a business selected from a list of businesses and rank one or more hits related to the mini-tab higher than all hits not related the mini-tab. For example, a search function within a payroll mini-tab can rank one or more hits related to payroll data higher than other hits not related to payroll data.

In some embodiments of the invention, the information pane can include a mini-tab that contains a search function, wherein the search function can be a find function. The find function can search data related to the mini-tab and/or data not related to the mini-tab. The find function can distinguish between data related to the mini-tab and data not related to the mini-tab prior to performing the search.

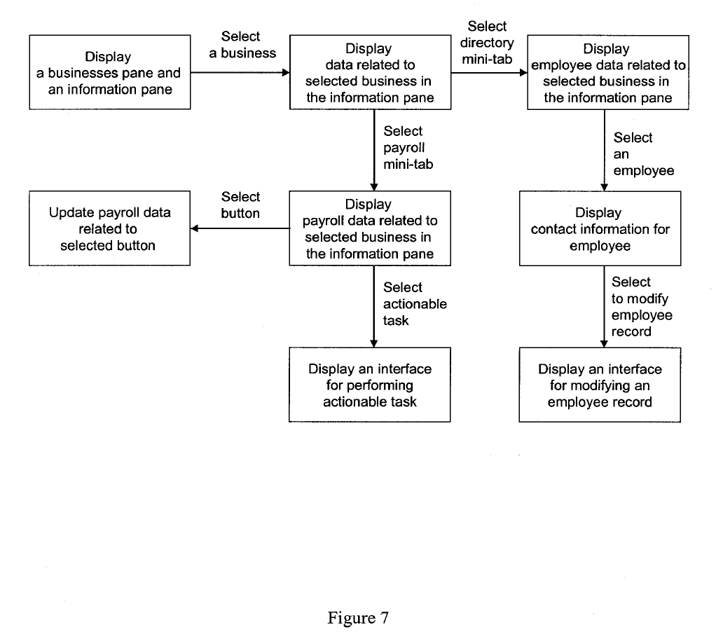

The user interface can allow for any data related to managing a business to be easily accessed. Any data related to managing a business can be accessed using a sequence of clicks. A click can include pointing to and clicking on a graphical user interface button, icon, or hyperlink. Pointing to and clicking on a graphical user interface button, icon or hyperlink is also is known as “selecting” the button, icon or hyperlink. As shown in FIG. 7, the user interface can provide access to data through a sequence of steps involving selection of options. Initially, a user interface can comprise displaying a businesses pane and an information pane, wherein the businesses pane shows a list of businesses. By selecting a business, the information pane can be populated with data related to the selected business from the list of businesses. The information pane can include one or more mini-tab to display one or more data sets related to the selected business. A mini-tab can display data related to managing a business. For example, data related to managing a business can be employee data, company data, or payroll data. Data related to managing a business can be displayed by selecting a mini-tab. For example, payroll data can be displayed by selecting a payroll mini-tab designed to display payroll data. A mini-tab can include a button, a link, or a radio box for performing actions related to the data displayed on the mini-tab. For example, a payroll mini-tab can have a button for displaying an interface within the information pane to edit payroll data. A mini-tab can have a button to update data related to the button. As an example, a payroll mini-tab can have a button for approving payroll data. By selecting the button, payroll data status can be changed.

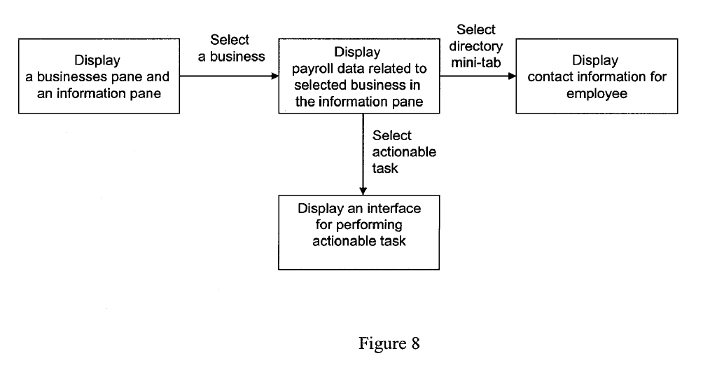

The user interface can allow for any data related to managing a business for a selected business from a list of businesses to be accessed in fewer than two, three, four, or five selections or clicks. In some embodiments of the invention, any data related to managing a business can be accessed without a search. For example, as shown in FIG. 7, payroll status data for a business can be accessed by clicking on the business from a list of businesses included in a businesses pane and then clicking on a mini-tab for payroll data. As shown in FIG. 8, when payroll data is most relevant to managing a business, a mini-tab for payroll data can be intelligently displayed when the business is selected from a list of businesses included in a businesses pane, requiring only one click to access payroll data. As another example, as shown in FIG. 7, contact information data for an employee of a business can be accessed by clicking on the business from a list of businesses included in a businesses pane, clicking on a mini-tab for employee data containing a list of one or more employees, and then clicking on a link, button, or hyperlink corresponding to the employee. Contact information data for the employee can be displayed when the link, button or hyperlink corresponding to the employee is selected or clicked. As shown in FIG. 8, contact information for the employee of a business can be intelligently displayed when the mini-tab for employee data is selected. For example, when data related to managing a business for the employee is missing, the user interface can display contact information data for the employee when the mini-tab for employee data is selected, requiring only two clicks to access the contact information data for the employee. The method of accessing data by performing a sequence of clicks or selections can be used to access any data included in the user interface of the invention.

Methods of Implementing User Interfaces

The invention provides for a method of implementing a user interface for accessing payroll data or any data related to human capital management comprising displaying a businesses pane providing a list of businesses and an information pane providing information relating to each business within the list of businesses. The information pane can include one or more mini-tabs for displaying one or more sets of data related to a selected business from the list of businesses. The one or more mini-tabs can display one or more actionable tasks. In some embodiments of the invention, an interface can be displayed within the information pane for performing the one or more actionable tasks.

The one or more mini-tabs can display any data related to managing a business or human capital management. The one or more mini-tabs can also display data selected from the group consisting of employee data, company contact data, company historical data, company status data, shipping data, receiving data, order data, billing data, and transfer data.

In some embodiments of the invention, the one or more mini-tabs can include a payroll mini-tab that can display payroll data. The payroll mini-tab can display payroll data that requires action. The payroll mini-tab can include a button or a link for creating a new sheet to store data or to perform an action with the data.

In other embodiments of the invention, the one or more mini-tabs can include a mini-tab to display employee data, wherein the mini-tab to display employee data includes a list of one or more employee records.

### EXAMPLE

The user interface can comprise a series of steps for accessing any data related to managing a business for one or more business entities. As shown in FIG. 7, the initial user interface can include a page for displaying a businesses pane and an information pane (e.g. FIG. 2-6). The businesses pane can display one or more business entities by any methods known to those skilled in the arts. The information pane can display one or more of the following: a set of data related to all or some business entities, actionable tasks that can be related to all or some business entities, one or more due dates related to all or some business entities, a search function, or any other information relevant to human capital management.

Selecting a business from the list of businesses displayed in the businesses pane can cause a set of data to be displayed in the information pane. The set of data to be displayed can be a default set of data, a previously determined set of data, or any data most relevant to the selected business from the list of businesses. The information pane can include one or more mini-tabs to display data sets related to human capital management. These mini-tabs can display a payroll mini-tab or a directory mini-tab.

The payroll mini-tab can display payroll data. Selecting the payroll mini-tab can cause payroll data to be displayed. The payroll data that is displayed can be payroll data that has been determined to be most relevant to a selected business from the list of businesses. The payroll mini-tab can include one or more buttons to update payroll data (e.g. FIG. 3-4). Selecting the button to update payroll data can cause the payroll data related to the button to be updated. The payroll mini-tab can display one or more actionable tasks. Selecting an actionable task can allow for an interface to be displayed to perform the actionable task. The interface for performing the actionable task can be within the information pane or in addition to the information pane.

The directory mini-tab can display employee data. Selecting the directory mini-tab can cause employee data to be displayed (e.g. FIG. 6). The directory mini-tab can display one or more employee names or other identifiers. Selecting an employee name or other identifier can cause contact information for the selected employee to be displayed. The directory mini-tab can include a button for modification of an employee record. Selecting the button can allow for an interface to be displayed to modify an employee record.

It should be understood from the foregoing that, while particular implementations have been illustrated and described, various modifications can be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents.

What is claimed is:

1. A system for accessing payroll data comprising:
a client computer;
a server operably connected to the client computer; and
a database coupled to the server to store data;
wherein the client computer has a user interface with a businesses pane providing a list of businesses and an information pane providing information relating to each business within the list of businesses; and further wherein
the information pane includes one or more mini-tabs to display one or more sets of data related to a selected business from the list of businesses.

2. The system of claim 1, wherein the one or more mini-tabs include a payroll mini-tab that displays payroll data.

3. The system of claim 1, wherein the server transmits data to be displayed by the client computer.

4. The system of claim 1, wherein the one or more mini-tabs display one or more actionable tasks.

5. The system of claim 4, wherein the information pane displays an interface for performing a selected actionable task from the one or more actionable tasks.

6. The system of claim 2, wherein the payroll mini-tab displays payroll data that requires action.

7. The system of claim 2, wherein the payroll mini-tab includes a link to a payroll page for editing payroll data.

8. The system of claim 1, wherein the information pane includes one or more items selected from the group consisting of a button, a link, a picture, or a map.

9. The system of claim 1, wherein the information pane includes a search function that searches any data related to the selected business from the list of businesses.

10. A user interface for accessing payroll data comprising:
a businesses pane providing a list of businesses; and
an information pane providing information relating to each business within the list of businesses, wherein the information pane includes one or more mini-tabs to display one or more sets of data related to a selected business from the list of businesses.

11. The user interface of 10, wherein the one or more mini-tabs include a payroll mini-tab that displays payroll data.

12. The user interface of claim 11, wherein the payroll mini-tab displays one or more of the following: payroll data that requires action, payroll data relating to a period of time, payroll data relating to a pay period, or employee work group information.

13. The user interface of claim 11, wherein the one or more mini-tabs display one or more actionable tasks.

14. The user interface of claim 13, wherein the information pane displays an interface to perform a selected actionable task from the one or more actionable tasks.

15. The user interface of claim 11, wherein the payroll mini-tab includes a button or a link to edit payroll data, create a new sheet to store data, or perform an action with payroll data.

16. The user interface of claim 10, wherein the information pane includes a mini-tab to display data selected from the group consisting of employee data, company contact data, company historical data, company status data, shipping data, receiving data, order data, billing data, and transfer data.

17. The user interface of claim 10, wherein the information pane includes a mini-tab to display data related to managing a business.

18. The user interface of claim 16, wherein the mini-tab to display employee data includes a list of one or more employee records.

19. The user interface of claim 18, wherein an employee record can be accessed without a search.

20. The user interface of claim 18, wherein selecting an employee record displays additional data relating to the employee.

21. The user interface of claim 10, wherein the information pane includes a search function that searches any data related to the selected business from the list of businesses.

22. The user interface of claim 10, wherein a mini-tab includes a search function, and further wherein one or more hits related to the mini-tab are ranked higher than one or more hits not related to the mini-tab.

23. The user interface of claim 21, wherein the search function only searches data related to the selected business from the list of businesses.

24. A method of implementing a user interface for accessing payroll data comprising
displaying within the user interface a businesses pane providing a list of businesses and an information pane providing information relating to each business within the list of businesses, wherein the information pane includes one or more mini-tabs for displaying one or more sets of data related to a selected business from the list of businesses.

25. The method of claim 24, wherein the one or more mini-tabs include payroll mini-tab that displays payroll data.

26. The method of claim 25, wherein the payroll mini-tab displays payroll data that requires action.

27. The method of claim 24, wherein the one or more mini-tabs display one or more actionable tasks.

28. The method of claim 27, wherein the information pane displays an interface for performing a selected actionable task from the one or more actionable tasks.

29. The method of claim 25, wherein the payroll mini-tab includes a button or a link for creating a new sheet to store data or to perform an action with the data.

30. The method of claim 24, wherein the information pane includes a mini-tab to display data selected from the group consisting of employee data, company contact data, company historical data, company status data, shipping data, receiving data, order data, billing data, and transfer data.

31. The method of claim 30, wherein the mini-tab to display employee data includes a list of one or more employee records.

32. The method of claim 24, wherein the information pane includes a mini-tab to display data related to managing a business.

33. A computer readable medium having program instructions recorded thereon for implementing a method comprising:
displaying a businesses pane providing a list of businesses and an information pane providing information relating to each business within the list of businesses, wherein the information pane includes one or more mini-tabs for displaying one or more sets of data related to a selected business from the list of businesses.

34. The computer readable medium of claim 33, wherein the one or more mini-tabs include a payroll mini-tab that displays payroll data.
